(19) United States
(12) Patent Application Publication
(10) Pub. No.: US 2020/0141642 A1
(43) Pub. Date: May 7, 2020

(54) INFRARED RADIATOR

(71) Applicant: VOITH PATENT GMBH, HEIDENHEIM (DE)

(72) Inventors: JUAN PANIAGUA, MOENCHENGLADBACH (DE); DIRK HOECKELMANN, MOENCHENGLADBACH (DE); PHILIPP KUECKMANN, MOENCHENGLADBACH (DE); REGGY SIMON TEDJA, MOENCHENGLADBACH (DE)

(21) Appl. No.: 16/609,024

(22) PCT Filed: Feb. 19, 2018
(86) PCT No.: PCT/EP2018/053993

§ 371 Date: Oct. 28, 2019

(30) Foreign Application Priority Data
Apr. 28, 2017 (DE) 10 2017 109 151.3

(51) Int. Cl. F26B 3/30; F23D 14/12; F23D 14/14

(52) U.S. Cl. CPC F26B 3/305; F26B 3/04; F23D 14/14; F23D 14/125

(57) ABSTRACT

An infrared radiator for the heat treatment of a material web has an incandescent body, which is flowed along a flow-receiving surface by a gas-air mixture supplied to the infrared radiator and heated by combustion of the gas-air mixture. The incandescent body has a surface with which the gas-air mixture or combustion products thereof come into contact. A ratio of the surface area of the incandescent body to the surface area of the flow-receiving surface of the incandescent body is greater than two.

The invention relates to an infrared radiator and to a drying arrangement, specifically according to the independent Claims.

Generic infrared radiators are used in drying arrangements for heat treatment, such as drying a material web, for example a paper, tissue or cardboard web. These drying arrangements are part of machines for manufacturing and/or treating such material webs. Nonwoven glass fabrics would also be possible. A preferred area of application is the drying of moving paper, tissue or cardboard webs in paper mills, for example behind coating devices, viewed along the running direction of the material web.

Infrared radiators that are known in the art have for example a plurality of rods that are preferably arranged in one plane, i.e. that are coplanar. However, arranging the rods in a plurality of parallel planes arranged at a distance from a burner plate is also known. The rods of generic infrared radiators are made of ceramic. Infrared radiators of this kind may be gas-powered. In that case, a burner is associated with them. This burner is operated with a gas-air mixture. The burner has a burner plate that is charged with the gas-air mixture. The gas-air mixture is ignited, for example using an electrode. The resulting flame heats the rods. The rods serve as incandescent bodies. They transfer the heat to the material web in the form of infrared radiation. In place of rods, highly heat-resistant metals, for example in the form of grids or porous ceramics, are also known as incandescent bodies.

Infrared radiators of this kind are used as surface radiators in the heat treatment of material webs. For this purpose, a multiplicity of such infrared radiators are arranged next to each other along the width and/or length of the material web to be treated. The required number of radiators is selected based on the width of the material web to be dried and the desired heating power. Using such infrared radiators, surface temperatures of 1100° C. and above may be achieved on the incandescent body.

A drawback of infrared radiators known from the prior art is that their radiation efficiency is not optimal for every application. It has also been shown that the gas-powered infrared radiators that are known in the art produce a very high proportion of nitrogen oxides (NOx) and carbon monoxides (CO) from the combustion of the gas-air mixture.

The present invention relates to the above-discussed subject matter.

The object of the invention is to create an infrared radiator and a drying arrangement that is improved over the prior art. In particular, it is sought to improve the radiation efficiency, as well as the exhaust gas behavior of the infrared radiator and the drying arrangement with regard to nitrogen oxides and carbon monoxide.

This object is accomplished by means of an infrared radiator and a drying arrangement according to the features of the independent claims.

To date, it has been assumed that an infrared radiator will accomplish the object according to the invention if the surface of the incandescent body is made to be as large as possible. Recently, pore burners have also become known for this, the incandescent bodies of which are made of a sponge-like, open-pored ceramic. However, the inventors have come to understand that the size of the surface of the incandescent body is not the only factor. Research has shown that the radiation efficiency of such an infrared radiator may be considerably increased and the exhaust gas values may be reduced to a comparatively great degree if the quotient of the surface area of the incandescent body and the surface area of the flow-receiving surface of the incandescent body—referred to in this case as the surface area ratio—is selected according to claim 1.

The term “radiation efficiency” refers to the ratio of the power supplied by the infrared radiator to the power it radiates—here, in the form of infrared radiation.

An infrared radiator according to the present invention dries a material web, for example in the intended operation (operating state) of the drying arrangement or the machine. This is the state in which the gas-air mixture within the infrared radiator burns and simultaneously heats the (at least one) incandescent body. Combustion may take place in the space bounded by the burner plate and at least one incandescent body—in this case referred to as the combustion chamber.

An incandescent body, in the sense of the present invention, is thus the object through which the gas-air mixture or its combustion products flow, and which is heated as a result of the combustion of the gas-air mixture. It is the part of the infrared radiator that glows due to being heated. Incandescence refers to the emission of radiation that is visible to the human eye. The incandescent body may be that part of the infrared radiator arranged behind the burner plate in the flow direction of the gas-air mixture. It may be at a distance from or in contact with the burner plate. The incandescent body is thus heated by the flames that are generated as a result of the combustion process, for example, on the side of the burner plate facing the incandescent body. The incandescent body could also be said to comprise all those elements that, together with the burner plate, delimit the combustion chamber of the infrared radiator. The at least one incandescent body may represent the outermost surface of the infrared radiator, which is directly opposite the material web to be treated. In such a case, the incandescent body is then arranged between the burner plate and the material web.

For the purpose of the invention, a “material web” is a fibrous web, i.e. a scrim or tangle of fibers such as cellulose fibers, plastic fibers, glass fibers, carbon fibers, additives, admixtures or the like. For example, the material web may be a paper web, cardboard web or tissue web. The web may substantially comprise cellulose fibers, with small quantities of other fibers or additives and admixtures being present. This adaptation to a particular application is left to the skilled person.

References to the flow direction of the gas-air mixture in the invention refer to the main flow direction of the particles of the gas-air mixture. This direction corresponds, for example, to a perpendicular to the largest surface of the burner plate of the infrared radiator through which the gas-air mixture flows (the flow-receiving surface of the burner plate). The flow-receiving surface may therefore be at least one delimiting side, i.e. the surface spanned by the spatial length and width of the burner plate. The delimiting side may be spanned by the long and wide edges (of the flow-receiving surface) of the burner plate. Thus, the gas-air mixture may flow through the burner plate at the largest delimiting surface thereof that faces the gas supply or the premixing chamber. If the burner plate is designed as a cuboid, the flow-receiving surface is at least one side face of the cuboid. Because the incandescent body or its envelope may also be designed as a cuboid, the flow-receiving surface of the incandescent body is also a side face (delimiting surface) of the cuboid, which represents a flat surface. Therefore, the above definition also applies analogously to the incandescent body and its flow-receiving surface. Thus the incandescent body is also flowed along this flow-receiving surface together with the gas-air mixture or the combustion products thereof. The flow direction of the gas-air mixture may also be perpendicular to the largest delimiting surface or flow-receiving surface. The flow direction of the gas-air mixture through the incandescent body may be the same as the flow direction through the burner plate. The flow-receiving surface of the incandescent body may be identical to the flow-receiving surface of the burner plate, so that both have the same area. It may be the surface that the incandescent body and the burner plate share when they abut one another directly.

References to the surface of the incandescent body refer to that surface of the incandescent body that comes into contact with the gas-air mixture, the combustion product thereof or the flames that result from combustion during operation of the infrared radiator, i.e. the surface through which the mixture flows. Put differently, it refers to the surface of the incandescent body that glows when the infrared radiator is in operation. In distinction from the flow-receiving surface, the surface of the incandescent body is the surface that is covered by the burning gas-air mixture. The incandescent body itself may be made up of a plurality of individually designed elements. The surface of the incandescent body may also be a complex spatial, non-planar outer surface, such as a free-form surface. If the incandescent body for example is designed in the manner of a grid—viewed in a viewing direction along the flow direction of gas-air mixture—preferably only those elements belong thereto that form or delimit the grid in this view.

The incandescent body may have a multiplicity of openings that are permeable to the gas-air mixture. It may be designed in such a way that the product of the area ratio and edge area ratio is greater than 1 and preferably between 2 and 10. The edge area ratio here is defined as the quotient of the difference between the surface area of all openings of the incandescent body and the surface area of its flow-receiving surface (the difference is the numerator of the fraction), and the surface area of the incandescent body's flow-receiving surface (this being the denominator of the fraction). The surface area is always to be viewed in a plane perpendicular to the flow direction of the gas-air mixture, i.e. in a parallel projection of the incandescent body in the flow direction of the gas-air mixture onto a plane perpendicular thereto. The edge area ratio thus gives the proportion of the edge of the incandescent body that delimits the openings, in relation to the flow-receiving surface thereof. The edge area ratio may also be rewritten as follows: If the incandescent body is illuminated in the same direction—i.e. perpendicular to the flow-receiving surface—with light instead of the gas-air mixture, a shadow is cast on an image plane arranged behind it. Due to the light that shines through the openings of the incandescent body, the openings are represented as bright spots and the edges thereof as shadows. The flow-receiving surface corresponds to the entire illuminated area. To ascertain the edge area ratio, the shaded area is now ascertained, for example by subtracting the surface areas of the bright spots from that of the entire illuminated flow-receiving surface and then expressing these surface areas as a proportion thereof. The inventors have recognized that the advantages of the invention may be realized even better by taking the area ratio into account.

When reference is made in the present invention to one element directly abutting another element, this means that the two elements are in direct contact with each other without anything else—and, preferably, without any distance—between them.

If the invention refers to ceramic, this is understood as a technical ceramic. Examples of this include, for example, silicon carbide and molybdenum silicide. High-temperature-resistant metals such as FeCrAl compounds or heat conductor alloys would also be suitable, in principle, as materials for incandescent bodies.

If reference is made to the incandescent body being made of a plurality of layers arranged one above the other, this means that a plurality of layers may also be provided that are arranged one behind the other in the flow direction of the gas-air mixture. This means that the layers are stacked one above the other, when viewed in the flow direction of the gas-air mixture. This affords, according to the invention, the advantage that the exhaust gas values may be further improved.

The term “at least partially” refers to at least a part of the incandescent body.

If reference is made to one element surrounding another at least partially, this means that it either partially or completely surrounds or envelops the corresponding element.

The term “primary forming” means that the relevant element has been manufactured by a manufacturing process in which a solid body is generated from a formless substance. Examples of this are casting, sintering, 3D printing.

The invention also relates to the incandescent body of claim 1 per se, as well as such a body having the features of the dependent claims.

Furthermore, the invention relates to a drying arrangement for heat treatment of a material web, comprising at least one infrared dryer that has a plurality of infrared radiators according to the invention, preferably arranged in the width and/or length direction of the material web to be treated.

Finally, the invention relates to a machine for manufacturing and/or treating a material web, preferably a paper machine, comprising at least one infrared radiator according to the invention, or such a drying arrangement.

The invention is described in greater detail below with reference to the drawings, without restricting the invention's generality. The drawings show the following:

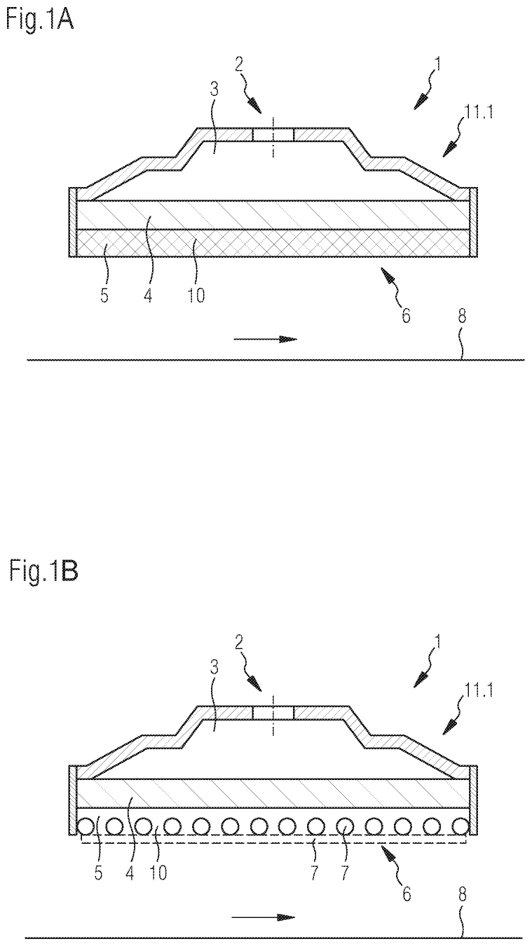

FIGS. 1a and 1b respectively a schematic, partially cut-away and not-to-scale representation of one embodiment of an infrared radiator;

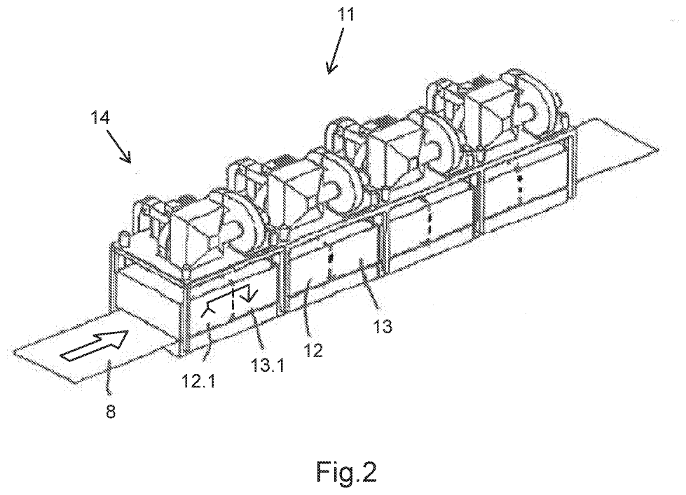

FIG. 2a highly schematized representation of a drying arrangement in a three-dimensional view according to one embodiment.

FIGS. 1a and 1b show two exemplary embodiments of the invention in a schematic, partially cut-away view through a plane that is perpendicular to the material web and parallel to the running direction (indicated by the arrow). Both drawings respectively show an infrared radiator 1, which may be part of a drying arrangement (see FIG. 2). During normal operation, the infrared radiator 1 is arranged at a distance from the material web 8, for example above it. The radiator forms a burner that is arranged in a housing 11.1. This housing has, for example, a rear wall and a plurality of side walls. The rear wall is located on the side (rear side) of the infrared radiator 1 facing away from the material web 8. An opening 2 is provided in this wall, through which an ignitable, combustible gas-air mixture may enter a mixing chamber 3. The corresponding supply lines outside the infrared radiator 1 are not shown in detail. The mixing chamber 3 is delimited on one side by a gas-permeable burner plate 4 and on the other side by the housing 11.1, here the rear wall thereof. The gas-air mixture flows into the burner plate 4 at a flow-receiving surface corresponding to the rear side of the infrared radiator 1 and passes through the gas-permeable burner plate 4, to be combusted. From there the mixture flows into a combustion chamber 5. This chamber is delimited or formed jointly by the burner plate 4 and an incandescent body 6. The gas-permeable burner plate 4 may be said to separate the mixing chamber 3 from the combustion chamber 5. In the latter chamber, the gas-air mixture ignites. The heat released heats the incandescent body 6 until this body begins to glow. As a result, the body emits infrared rays toward the material web 8 to be dried. Both the burner plate 4 and the incandescent body 6 have a slab-shaped or cuboidal outer contour. In principle, a different outer contour would be possible. In this case, the flow-receiving surface of the incandescent body 6 corresponds to the flow-receiving surface of the burner plate 4. In other words, the two flow-receiving surfaces are the same. They correspond in this case to the clear width of the housing 11.1 that accommodates both the burner plate 4 and the incandescent body 6.

Irrespective of the embodiment shown, the infrared radiator 1 with its incandescent body 6 faces the material web 8; in the case shown, it does so in such a way that the incandescent body 6 runs parallel thereto. However, this need not necessarily be the case. The infrared radiator 1 may also run at an angle thereto. As shown in FIGS. 1a and 1b, the burner plate 4 and the incandescent body 6 are connected in series, viewed in the flow direction of the gas-air mixture. The incandescent body 6 is arranged downstream of the burner plate 4.

According to the embodiment of FIG. 1a, the incandescent body 6 is designed as a gas-permeable regular grid. This grid may be made of a multiplicity of identical (i.e. having the same size) unit cells. The unit cells represent an open-cell structure. Consequently, the gas-air mixture passing through the burner plate 4 may flow through all unit cells. The unit cells thus represent openings in the incandescent body 6.

In the present case, the incandescent body 6 directly abuts the burner plate 4. This means that both are arranged without distance from each other and preferably parallel to each other. This means that the flow-receiving side of the burner plate 4, i.e. the side facing away from the material web 8, and the flow-receiving side of the incandescent body 6, i.e. the side of the incandescent body 6 facing away from the burner plate 4, run parallel to each other. It could also be said that the aforementioned flow-receiving side corresponds to the flow-receiving surface according to the invention. In the present case, the flow-receiving side is also the largest side delimiting the cuboidal incandescent body 6. Because the burner plate 4 and the incandescent body 6 are arranged with no distance between them, the combustion chamber 5 here is formed by the cavity of the incandescent body 6 that is formed by the openings or is delimited along with the burner plate 4 and the incandescent body 6. This means that the gas-air mixture that first flows through the burner plate 4 and then through the incandescent body 6 is ignited in the combustion chamber 5 (for example by means of an electrode, not shown), and then burns down inside the incandescent body 6, or more precisely inside the cavity 10 thereof, to produce combustion products.

According to the invention, the incandescent body 6 is designed in such a way that the area ratio, i.e. the ratio of the surface area of the surface of the incandescent body 6 to the surface area of the flow-receiving surface of the incandescent body 6, is greater than two. The surface of the incandescent body 6 is the surface that glows as a result of the combustion of the gas-air mixture. It corresponds to the border, i.e. the wall of the multiplicity of unit cells or openings of the incandescent body 6. The flow-receiving surface is the surface area of the planar and longest delimiting side of the incandescent body 6, i.e. in this case the surface area that the burner plate 4 and incandescent body 6 share. By selecting the ratio according to the invention, the radiation efficiency of such an infrared radiator 1 may be considerably increased, together with a reduction in the nitrogen oxides and carbon monoxides produced during combustion.

In the embodiment of FIG. 1b, the incandescent body 6 is formed by a multiplicity of rods 7. The rods 7 are held in the area of their axial ends in the housing 11.1, or more precisely in the side walls thereof, so that they cannot be lost. In this case, a plurality of rods 7 is provided for each infrared radiator 1. In FIG. 1b, the longitudinal center lines of these rods are coplanar to each other, and are parallel to the material web 8 as it runs past the infrared radiator 1. In this plane, the rods are arranged at a distance from each other, viewed with respect to their longitudinal center lines. The shortest distance between the longitudinal center lines of two immediately adjacent rods 7, in this case, may be more than half the thickness of the respective rod 7. In this case, the incandescent body 6 is arranged at a distance from the burner plate 4 in the flow direction of the gas-air mixture or the combustion products thereof. In the present case, the total surface area of the incandescent body 6 corresponds to the sum of the outer surfaces of the multiplicity of rods 7. Here too, the flow-receiving surface is in the plane spanned by the length and width extension, the length extension being perpendicular to the image plane and the width extension of the incandescent body 6 being perpendicular thereto, i.e. in this case, from left to right and thus parallel to the running direction of the material web.

Irrespective of the embodiment shown, it would be possible in principle, for example, to furnish a plurality of such planes of rods 7 or a plurality of layers of an incandescent body 6, and these could be arranged at a distance from the burner plate 4 in the flow direction of the gas-air mixture or the resulting combustion products.

As shown in the drawings, the incandescent body 6 may be designed in such a way that it has the form of a grid, in the viewing direction of the gas-air mixture. In the case of FIG. 1b, one of the first layers of rods 7—viewed along an extension of the flow direction of the gas-air mixture—would be placed subsequent to the second layer. This is indicated here by the dashed lines. In this case, the rods 7 of the first layer are arranged rotated by 90° relative to the rods 7 of the second layer, so as to form a grid when viewed in the viewing direction of the gas-air mixture.

Irrespective of the embodiment shown, the area ratio according to the invention could be greater than 4, greater than 6 or greater than 11. The area ratio may also be between 2 and 50, preferably between 6 and 15. It has been shown that in this way a particularly good radiation efficiency may be achieved with the infrared radiator 1. The inventors have recognized that the exhaust emissions of such an infrared radiator 1 may also be significantly improved if, in addition to the area ratio according to the invention, the edge area ratio of the incandescent body is also taken into account analogously. The product is formed from the area ratio and the edge area ratio and the value is selected as set forth in claim 4. The edge area ratio represents the quotient of the difference between the surface area of all openings of the incandescent body 6 and its flow-receiving surface in relation to the flow-receiving surface of the incandescent body 6, respectively viewed in a parallel projection of the incandescent body 6 in the flow direction of the gas-air mixture on a plane perpendicular thereto.

Although this is not shown in the drawings, the infrared radiator 1 could be designed as a pore burner, and its incandescent body 6 could then be made of a sponge-like, open-pored ceramic.

FIG. 2 shows a possible embodiment of a drying arrangement 11 according to the invention. This may be part of a machine for manufacturing or treating a material web. The drying arrangement 11 here is arranged behind a coating or binder section (not shown) of the machine, in the running direction of the material web 8. Within this section, a coating color or binder is applied to the material web 8. As a result of this application, the material web 8 absorbs moisture and must therefore be dried, or the binder must be cured. This is done in the drying arrangement 11.

The drying arrangement 11 comprises one or, as shown here, a plurality of infrared dryers 12, each of which respectively has a multiplicity of infrared radiators 1 that serve as surface radiators and are preferably arranged parallel to the material web 8. In addition, the drying arrangement 11 also has a plurality of air dryers 13. In the present case, an infrared dryer 12 is respectively downstream of an air dryer 13 when viewed in the running direction of the material web 8, and so forth. Such an infrared dryer 12 and air dryer 13 are respectively referred to as a combination dryer 14. Four combination dryers 14 are furnished, arranged one behind the other in the running direction of the material web 8 to be dried. These combination dryers are, in this case, arranged directly abutting one another. Consequently, when the material web 8 to be dried leaves a first combination dryer 14, it immediately reaches the following combination dryer 14 viewed in the running direction. All combination dryers 14 are set up in such a way that, viewed in the running direction of the material web, drying occurs by infrared radiation from the associated infrared dryer 12, then by convection through the corresponding air dryer 13, by heat radiation and so on alternatingly. As soon as the material web 8 has left the first combination dryer 14 as viewed in the running direction of the web, it is transferred to the second combination dryer 14. There in turn, as viewed in its running direction, the web is first dried by the corresponding infrared dryer 12 and then by the corresponding air dryer 13. In other words, an air dryer 13 assigned to the first combination dryer 14 is arranged between an infrared dryer 12 of a first combination dryer 14 in the running direction and an infrared dryer 12 of another combination dryer 14 immediately following it in the running direction—viewed respectively in the running direction of the material web 8 through the drying arrangement 11. One could also say that the material web 8 is dried along the drying arrangement 11 alternatingly by heat radiation, then by convection, again in turn by heat radiation and so on.

The infrared dryer 12 of a respective combination dryer 14 may be designed as a gas-heated infrared dryer according to the invention. In this case, the infrared dryer 12 may comprise one or more infrared radiators 1 according to the invention (see FIGS. 1a and 1b). The combustion products (exhaust gases) that the infrared radiators 1 generate may then be extracted from the infrared dryer 12 via one or more suction nozzles 12.1 associated with the infrared dryer 12, only one of which is indicated here in a purely schematic manner. The at least one suction nozzle 12.1 may be arranged inside a housing that surrounds the infrared dryer 12.

The respective air dryer 13 may comprise one or more blowing nozzles 13.1, of which only one is shown here, likewise in a purely schematic manner. The at least one blowing nozzle 13.1 serves, among other things, to supply heated air to the material web 8 for drying. For this purpose, the at least one blowing nozzle 13.1 may be connected to a fresh air supply (not shown) in a flow-conducting manner. In addition, a flow-conducting connection may be furnished between the at least one suction nozzle 12.1 and the at least one blowing nozzle 13.1 of the same combination dryer 14. The thermal energy contained in the exhaust gas of the infrared dryer 12 may be used to heat the fresh air or to dry the material web 8 using the thermal energy of the exhaust gas of the respective infrared dryer 12.

1-16. (canceled)

17. An infrared radiator for the heat treatment of a material web, the infrared radiator comprising:
an incandescent body having a flow-receiving surface disposed to be impinged by a gas-air mixture supplied to the infrared radiator and to be heated by a combustion of the gas-air mixture, said flow-receiving surface having a surface area;
said incandescent body having a surface with which the gas-air mixture or combustion products thereof come into contact, said surface having a surface area; and
a surface area ratio of the surface area of said incandescent body to the surface area of said flow-receiving surface of the incandescent body being greater than two.

18. The infrared radiator according to claim 17, wherein the surface area ratio is greater than 4.

19. The infrared radiator according to claim 18, wherein the surface area ratio is greater than 6 or greater than 11.

20. The infrared radiator according to claim 17, wherein the surface area ratio is greater than 2 and less than or equal to 50.

21. The infrared radiator according to claim 20, wherein the surface area ratio lies between 6 and 15.

22. The infrared radiator according to claim 17, wherein:
said incandescent body is formed with a multiplicity of openings through which the gas-air mixture may pass; and
said incandescent body is formed to define a product of the surface area ratio and an edge area ratio greater than 1, the edge area ratio being defined by taking a quotient of a difference between a surface area of all of said openings of said incandescent body and said flow-receiving surface in relation to said flow-receiving surface of said incandescent body, respectively viewed in a parallel projection of said incandescent body in a flow direction of the gas-air mixture onto a plane perpendicular thereto.

23. The infrared radiator according to claim 22, wherein the product of the surface area ratio and the edge area ratio is between 2 and 10.

24. The infrared radiator according to claim 17, wherein said flow-receiving surface is at least one delimiting side of said incandescent body.

25. The infrared radiator according to claim 17, further comprising a burner plate, and wherein said incandescent body is arranged behind said burner plate in a flow direction of the gas-air mixture.

26. The infrared radiator according to claim 25, wherein said incandescent body directly adjoins said burner plate in the flow direction of the gas-air mixture.

27. The infrared radiator according to claim 17, wherein said incandescent body comprises or is made of a ceramic and/or a metal.

28. The infrared radiator according to claim 17, wherein said incandescent body, viewed in a flow direction of the gas-air mixture, is at least partially formed as a grid.

29. The infrared radiator according to claim 28, wherein said grid is at least partially a regular grid made up of a multiplicity of identical unit cells.

30. The infrared radiator according to claim 17, wherein said incandescent body is formed of a single layer or a plurality of layers that are arranged one above the other.

31. The infrared radiator according to claim 17, wherein, viewed in a flow direction of the gas-air mixture, said incandescent body is formed of a plurality of layers defining a grid.

32. The infrared radiator according to claim 17, wherein said incandescent body is a three-dimensional grid.

33. The infrared radiator according to claim 32, wherein said incandescent body is manufactured as a single unit.

34. A drying arrangement for heat-treating a material web, the drying arrangement comprising:
at least one infrared dryer having a plurality of infrared radiators arranged in a width and/or length direction of the material web to be treated;
each of said infrared radiators being an infrared radiator according to claim 17.

35. The drying arrangement according to claim 34, further comprising at least one air dryer for directing hot air and/or a combustion product of the gas-air mixture from said plurality of infrared radiators onto the material web to be treated.

36. The drying arrangement according to claim 35, wherein said at least one air dryer and said at least one infrared dryer are arranged one behind another as viewed in a running direction of the material web to be treated, and wherein the at least one infrared dryer is connected upstream of the at least one air dryer as viewed in the running direction of the material web to be treated.
